(19) United States
(12) Patent Application Publication
(10) Pub. No.: US 2011/0228298 A1
(43) Pub. Date: Sep. 22, 2011

(54) IMAGE FORMING APPARATUS, METHOD OF CONTROLLING IMAGE FORMING APPARATUS, AND STORAGE MEDIUM

(75) Inventor: Hideyuki Okada, Kawasaki-shi (JP)

(73) Assignee: CANON KABUSHIKI KAISHA, Tokyo (JP)

(21) Appl. No.: 13/046,314

(22) Filed: Mar. 11, 2011

(30) Foreign Application Priority Data
Mar. 16, 2010 (JP) 2010-059429

(51) Int. Cl. H04N 1/60

(52) U.S. Cl. 358/1.9

(57) ABSTRACT

An image forming apparatus includes a control unit configured to determine whether each of a plurality of pages where the print data is printed is likely to bring about tint variation; extract a page determined to be likely to bring about the tint variation, as a sample printing page that requires execution of sample printing to check tint on paper, and execute printing of the sample printing page and causes a print paper processing apparatus to output print product of the sample printing.

### BACKGROUND OF THE INVENTION

1. Field of the Invention

The present invention relates to an image forming apparatus that has a sample printing function that enables a partial output of print product corresponding to a print job and a visual inspection of finishing state of the print product by operator, a method of controlling the image forming apparatus, and a storage medium therefor.

2. Description of the Related Art

In recent years, electro-photographic printing apparatuses and copying machines have been used in the commercial printing field. In such field that deals with printing of a large number of sheets, the apparatuses and machines are required to print a large amount of copies continuously and efficiently without waste, and to maintain the consistent image quality of the copies produced by the printing process. In the printing of a large amount of copies, a post-processing apparatus such as a stacker is often coupled to a printing apparatus as paper discharge destination which can stack a large quantity of outcome of the printing. Some of the post-processing apparatuses for stacking a large quantity of outcome, however, incorporate a stacking portion within the apparatuses to prevent any adverse effect of external factors onto the stacking property of the apparatuses. In using such post-processing apparatuses, no operator can touch outcome in mid-course of printing operation, which precludes the inspection of the finishing state of the outcome during printing.

Japanese Patent Application Laid-Open No. 2007-41505 discusses an apparatus that enables inspection of the finishing state of outcome during printing of a large number of copies. Specifically, Japanese Patent Application Laid-Open No. 2007-41505 discusses a technology that, upon receipt of an instruction to check finishing state from an operator, copies a page that is currently printed, onto a sheet and discharges the sheet to a paper discharge destination (e.g., sample tray) where the operator can pick the sheet up for check of the finishing state. The technology enables a check of the finishing state of outcome by an operator during printing at any timing the operator desires. Herein, the printing of an outcome for inspection of the finishing state of the outcome as described above is referred to as sample printing. The print product of sample printing is output to be checked by an operator, which is referred to as sample output.

Japanese Patent Application Laid-Open No. 2007-41505 further discusses an approach for a printing system that is configured to automatically execute sample printing to show finishing state at every completion of printing of a predetermined number of copies or sets of copies or at regular time intervals. The system enables operator to visually check the finishing state at predetermined timings, without additional operations at appropriate timings.

There have been recently various formats of print products in the commercial printing field. For example, some instruction manuals each composed of a plurality of chapters are provided with division sheets for the chapters, bubble sheets, and graph paper, for example, and are sandwiched between front and back covers. The manuals are each punched to be put in a binder to be used as a textbook. In the printing of such print products, several types of paper (e.g., thin print paper, thick print paper) are used in addition to plain paper. In this way, printing has been performed to obtain print products each provided with a plurality of and different types of paper.

Usually, an electro-photographic printing apparatus appropriately changes the control of fixing temperatures and transportation speeds for each type of print paper to maximize image quality to be printed. The change causes tint variation appearing differently on different types of print paper. Accordingly, in checking the finishing state of print outcome in mid-course of printing, an operator wants to check the finishing state of every type of paper used in the printing. The conventional approach for sample printing, however, gives no consideration to different types of paper, and executes sample printing to check finishing state of the outcome only depending on the timings instructed for checking of the finishing state. As a result, in some cases depending on the timings, only the same type of paper is printed for sampling. This sample printing may lead to a problem that the printing is continued while an operator does not notice any larger tint variation in another type of paper.

### SUMMARY OF THE INVENTION

According to an aspect of the present invention, an image forming apparatus having a function to execute sample printing for a part of print data contained in a job to check a finishing state of print product when the print data is printed is provided, the image forming apparatus including: a determining unit configured to determine whether each of a plurality of pages where the print data is printed is likely to bring about tint variation when the page is printed; an extracting unit configured to extract a page determined to be likely to bring about the tint variation by the determining unit as a sample printing page that requires execution of sample printing to check tint on paper; and an output unit configured to execute sample printing of the sample printing page extracted by the extracting unit, and output a print product of the sample printing.

The present invention enhances effectiveness of checking the finishing state of print outcome by operator, through sample printing at more effective timing for the check.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a configuration diagram illustrating an image forming system applied to a first exemplary embodiment of the present invention.

FIG. 2 is a block diagram illustrating a printing system.

FIG. 3 is a cross sectional diagram illustrating a printing system.

FIG. 4 is a schematic diagram illustrating an operation unit.

FIG. 5 is a basic flowchart illustrating the first exemplary embodiment of the present invention.

FIG. 6 is a flowchart illustrating processes for sample printing corresponding to a job configuration according to the first exemplary embodiment.

FIG. 7A illustrates an example of a screen for receiving an instruction to execute sample printing.

FIG. 7B illustrates an example of an operation selection screen for sample printing.

FIG. 8 is a flowchart illustrating processes for sample printing corresponding to a job configuration according to a second exemplary embodiment.

FIG. 9 is a flowchart illustrating processes for sample printing corresponding to a job configuration according to a third exemplary embodiment.

### DESCRIPTION OF THE EMBODIMENTS

Various exemplary embodiments, features, and aspects of the invention will be described in detail below with reference to the drawings.

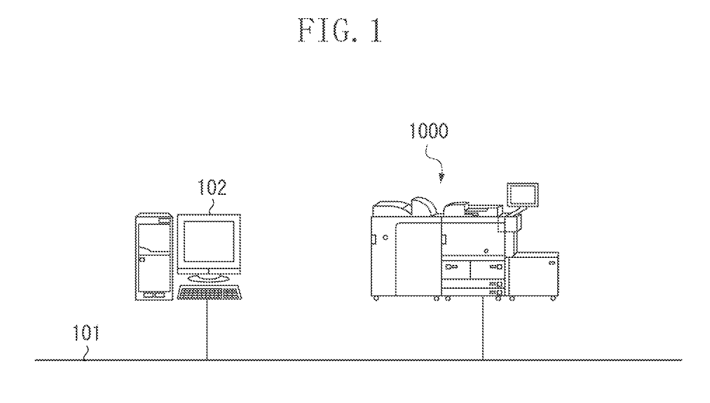

FIG. 1 is a configuration diagram illustrating an image forming system applied to a first exemplary embodiment of the present invention. The image forming system includes a printing system 1000 and a client computer 102 (hereinafter, referred to as PC 102) which are connected to each other through a network 101. The PC 102 transmits page description language (PDL) code data to the printing system 1000 as print data via the network 101. The printing system 1000 prints the print data received from the PC 102 to output a print product.

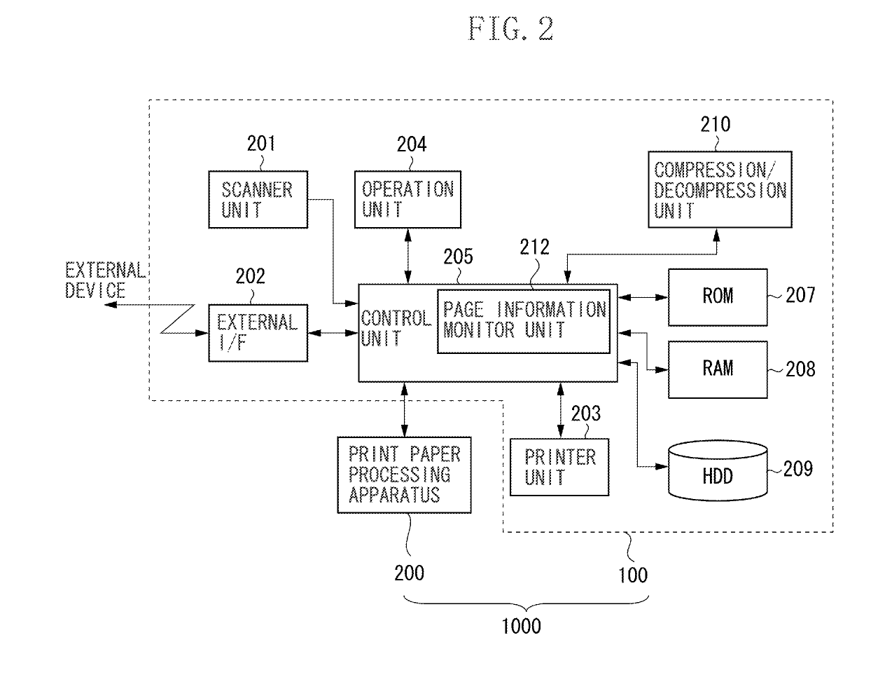

The printing system 1000 is described with reference to the system block diagram in FIG. 2. The printing system 1000 includes an imaging forming apparatus 100 located inside the dotted line in FIG. 2, and at least one print paper processing apparatus 200. Any number of the print paper processing apparatuses 200 can be connected to the imaging forming apparatus 100. In the present exemplary embodiment, as an example for description, the image forming apparatus 100 is a multi function peripheral (MFP) having a plurality of functions such as copying and printing. The image forming apparatus 100 may be, however, a single-function type printing apparatus only with copy function or print function.

In the present exemplary embodiment, the printing system 1000 is configured as described below. In the printing system 1000, the image forming apparatus 100 prints data on paper and outputs the paper as print product, and the print product is processed in the print paper processing apparatus 200 connected to the image forming apparatus 100. The printing system 1000 may include only the image forming apparatus 100, without the print paper processing apparatus 200.

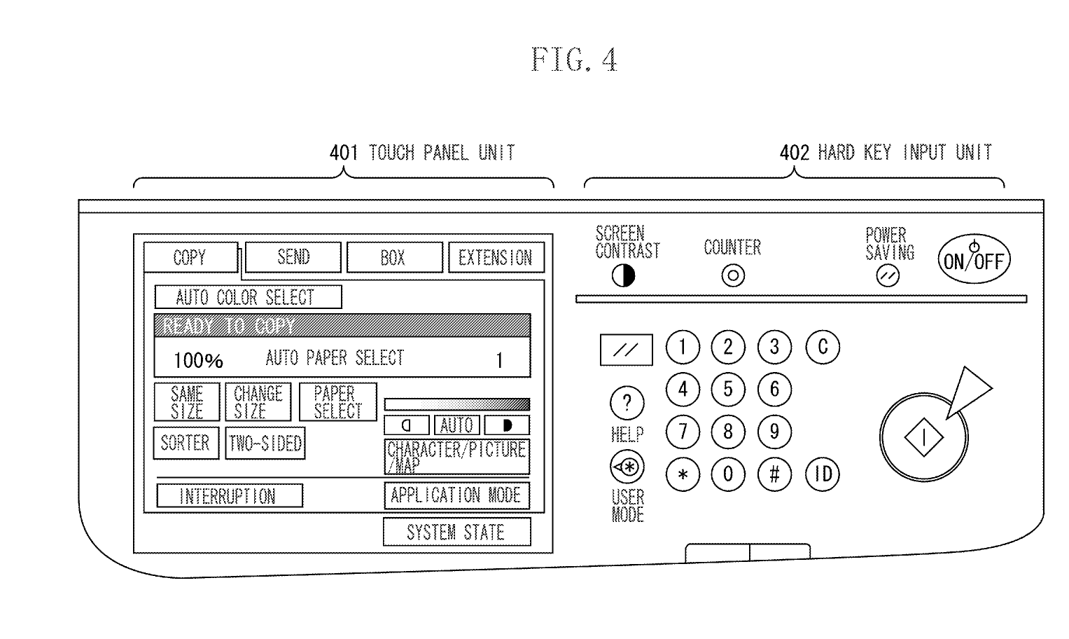

The print paper processing apparatus 200 is configured to be able to communicate with the image forming apparatus 100, so that the print paper processing apparatus 200 performs a paper process, which will be described later, on the print product output from the image forming apparatus 100, upon receipt of an instruction from the image forming apparatus 100. A scanner unit 201 reads the image on original document, and converts the image into image data, which is transmitted to another unit. An external I/F 202 transmits and receives data between other apparatuses (e.g., PC 102) connected to the network 101. A printer unit 203 prints image on paper based on the input image data. An operation unit 204 includes, as illustrated in FIG. 4, a hard-key input unit (key input unit) 402 and a touch panel unit 401 to accept instructions from operator. The operation unit 204 displays various information on the touch panel unit 401 of the operation unit 204.

A control unit 205 generally controls processes and operations performed by the units of the printing system 1000. In other words, the control unit 205 controls the operations of the image forming apparatus 100 and the print paper processing apparatus 200 connected to the image forming apparatus 100. For example, the control unit 205 selects a paper discharge destination to which print product is discharged, from a plurality of paper discharge destinations of the print paper processing apparatus 200, and controls a discharge process. The control unit 205 incorporates a page information monitor unit 212 therein. The page information monitor unit 212 monitors page information that is obtained as the interpretation result of PDL code data that is contained in print data received from the PC 102. Based on the page information monitored by the page information monitor unit 212, the control unit 205 extracts a page (sampling printing page) on which sample printing is executed to check the finishing state of print product.

A read only memory (ROM) 207 stores various computer programs executed by the control unit 205. For example, the ROM 207 stores programs which cause the control unit 205 to execute processes in flowcharts, which will be described later, and display-control programs that are necessary to display various setting screens, which also will be described later. The ROM 207 further stores programs that cause the control unit 205 to implement interpretation of PDL code data contained in print data received from the PC 102 and development of the data to raster image data. In addition, the ROM 207 stores boot sequence and font information. A random access memory (RAM) 208 stores image data and PDL code data transmitted from the scanner unit 201 and the external I/F 202, and various programs loaded from the ROM 207, and setting information. The RAM 208 further stores information about the print paper processing apparatus 200 (information about the type and function of each of the print paper processing apparatuses 200 connected to the image forming apparatus 100). The control unit 205 can control the print paper processing apparatus 200 using the information about the print paper processing apparatus 200 stored in the RAM 208. A hard disk drive (HDD) 209 is configured with a hard disk and a drive unit that reads data from the hard disk and writes data into the hard disk. The HDD 209 is a mass-storage device storing image data that is input from the scanner unit 201 and compressed by a compression/decompression unit 210. The control unit 205 can control the printer unit 203 to print the image data stored in the HDD 209 based on an instruction from an operator. The HDD 209 can be used as a spooler, so that the control unit 205 manages print data received from the PC 102 as a job, and stores the job in the HDD 209. The control unit 205 also can manage the jobs stored in the HDD 209, and can obtain the number of the stored jobs and the setting information of the jobs. The compression/decompression unit 210 compresses and decompresses image data stored in the RAM 208 and the HDD 209 using various compression technologies such as JBIG and JPEG.

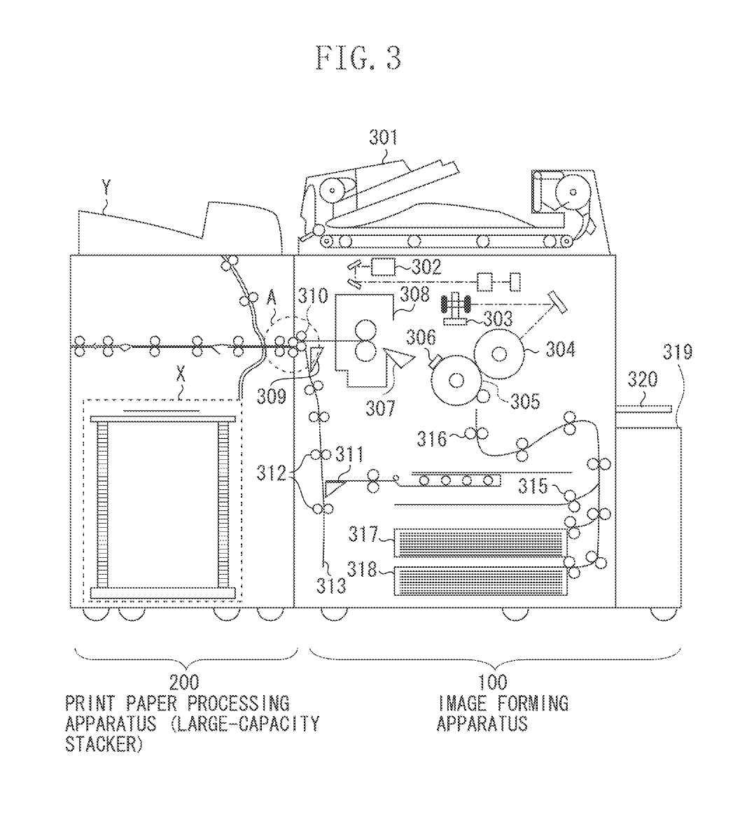

The configuration of the printing system 1000 is described with reference to FIG. 3. FIG. 3 is a cross sectional diagram illustrating the image forming apparatus 100 and the print paper processing apparatus 200 connected to the image forming apparatus 100. In FIG. 3, a large-capacity stacker to stack a large amount of paper is used as the print paper processing apparatus 200.

In FIG. 3, an automatic document feeder (ADF) 301 separates the pages of a stack of original document placed on a stacking face of a document tray, one by one in the stacked order, and transports the pages to a document positioning glass plate, where the pages are scanned by a scanner 302. The scanner 302 reads images of the original document transferred to the document positioning glass plate, and converts the images into image data using charge coupled devices (CCDs). A rotational polygon mirror 303 inputs a light beam such as a laser beam that is modified depending on the image data. The light beam is reflected by a reflection mirror, and illuminates a photosensitive drum 304, as reflected scanning light, to form a latent image on the photosensitive drum 304. The latent image is developed using toner, which is transferred to paper placed on a transfer drum 305 as a toner image. This series of image forming processes is sequentially executed for toners of four different colors: yellow (Y), magenta (M), cyan (C), and black (K), which completes a full-color image. After the image forming process is executed four times, the paper having the full-color image and placed on the transfer drum 305 is separated from the transfer drum 305 by a separation claw 306, and transported to a fixing device 308 by a pre-fixing carrier 307. The fixing device 308 is configured combining rollers and belts, and incorporates a heat source such as halogen heater therein, so that, with the heat and pressure, the fixing device 308 melts and fixes the toner on the paper where the toner image is transferred. A paper discharge flapper 309 is mounted to swing around a swing shaft to define a paper transport direction. When the paper discharge flapper 309 pivots clockwise in FIG. 3, paper is transported straight, and exits the printing apparatus through at least one paper discharge roller pair 310. The control unit 205 controls the image forming apparatus 100 to perform one-sided printing through the above sequence.

For two-sided printing, the paper discharge flapper 309 pivots counterclockwise in FIG. 3, so that a paper discharge path is switched to guide paper downward to a two-sided conveying unit. The two-sided conveying unit includes an inverse flapper 311, at least one inverse roller pair 312, an inverse guide 313, and a both sided tray 314. The inverse flapper 311 is mounted to swing around a swing shaft to define a paper transportation direction. For two-sided printing, the control unit 205 controls the inverse flapper 311 to pivot counterclockwise in FIG. 3 such that paper having an image on one side printed at the printer unit 203 is led to the inverse guide 313 through the inverse roller pair 312. When the tailing edge of the paper is sandwiched between the inverse roller pair 312, the inverse roller pair 312 is controlled to pause temporarily, and the inverse flapper 311 is caused to swing clockwise in FIG. 3. Then, the inverse roller pair 312 starts to rotate in the opposite direction. The rotation causes the paper to switch back for further transportation, changing the trailing edge of the paper to the leading edge, and the paper is led to the both sided tray 314 first. The paper is loaded on the both sided tray 314, and then is sent to at least one registration roller pair 316 again through at least one paper re-feed roller pair 315. During the transportation, a second side of the paper, which is opposite to the first side with image printed in the previous process, faces the photosensitive drum 304. The second side is printed with second image as in the above described process. After the image printing on both sides of the paper, the paper goes through a fixing process, and is discharged out of the image forming apparatus 100 through the paper discharge roller pair 310. The control unit 205 controls the image forming apparatus 100 to perform the two-sided printing through the above sequence of processes.

The image forming apparatus 100 includes a paper feed unit configured to store paper to be used in printing processes. The paper feed unit includes sheet cassettes 317 and 318 (e.g., cassettes for storing 500 sheets of paper each), a paper feed deck 319 (e.g., deck for storing 5000 sheets of paper), and a manual feed tray 320. The sheet cassettes 317 and 318 and the paper feed deck 319 are capable of sorting and setting different sizes and materials of paper for each paper feed unit. The manual feed tray 320 can accept various types of paper including special paper such as overhead projector (OHP) sheets. The sheet cassettes 317 and 318, the paper feed deck 319, and the manual feed tray 320 are each provided with paper feed rollers, so that paper can be fed successively one by one by the paper feed rollers.

The print paper processing apparatus 200 illustrated in FIG. 3 is described. In the configuration of the present exemplary embodiment, as an example, only a large-capacity stacker is connected. The printing system 1000, however, may be configured to include any number and type of apparatuses coupled with one another to transport paper from upstream to downstream through paper conveyance paths. In the case with a plurality of apparatuses, the control unit 205 accepts simultaneously both requests for paper processing and printing execution from an operator through the operation unit 204. The request for paper processing is selected by the operator from different paper processes executable by the print paper processing apparatuses 200 connected to the image forming apparatus 100. Upon the acceptance of the requests to execute printing of the job to be processed through the operation unit 204, the control unit 205 causes the printer unit 203 to execute the printing processes required for the job. The control unit 205 transports the printed paper through paper conveyance paths to the print paper processing apparatuses 200 which can execute the paper processes designated by the operator, where the paper processes are executed. The control unit 205, then, performs control such that the processed paper is discharged to a paper discharge unit provided in each of the involved print paper processing apparatuses 200. Consequently, the operator can pick up the processed paper from the paper discharge unit in each of the print paper processing apparatuses 200.

For example, an operator enters a job command for printing that requires a large amount of stacking processing by the print paper processing apparatus (large-capacity stacker) 200. The job is hereinafter referred to as stacker job. When the stacker job is executed by the system configuration in FIG. 3, the control unit 205 transports the paper printed by the image forming apparatus 100 in the job, into a large-capacity stacker through the A point in FIG. 3. The control unit 205 then causes the large-capacity stacker 200 to perform a stacking process for the job. The control unit 205 stores the print product of the job stacked at large-capacity stacker 200, in a paper discharge destination X provided within the stacker 200, without transporting the product to another apparatus (e.g., an apparatus connected downstream). This allows the operator to pick up the print product of the stacker job in the paper discharge destination X in FIG. 3 directly from there. The large-capacity stacker 200 has a paper discharge destination Y, in addition to the inner paper discharge destination X, outside of (above) the large-capacity stacker 200. Thus, the control unit 205 can perform control such that the paper transported in the large-capacity stacker is discharged to the paper discharge destination Y. The paper discharge destination X in the large-capacity stacker 200 has a cover at the opening thereof, which is in a locked state during printing process to prohibit access thereto. Accordingly, to pick up the stacked paper in paper discharge destination X, the printing process needs to be paused to unlock the cover. In contrast, paper discharged and stacked in the paper discharge destination Y can be accessed by an operator at any time during printing for checking.

In the present exemplary embodiment, the printing system 1000 includes various user interfaces that are interactively responsive to operations from the operator. These interfaces function as the unit configured to accept requests for job execution from the operator. Examples of the user interfaces are the operation unit 204, soft keys and hard keys at the operation unit 204, and user interface screens illustrated in drawings. These user interfaces are illustrative examples, and there may be other interfaces. For example, the interfaces may be configured to accept requests for job execution from apparatuses outside of the printing system 1000. In this case, the user interface provided at an external data source such as the PC 102 functions as the unit configured to accept requests for job execution.

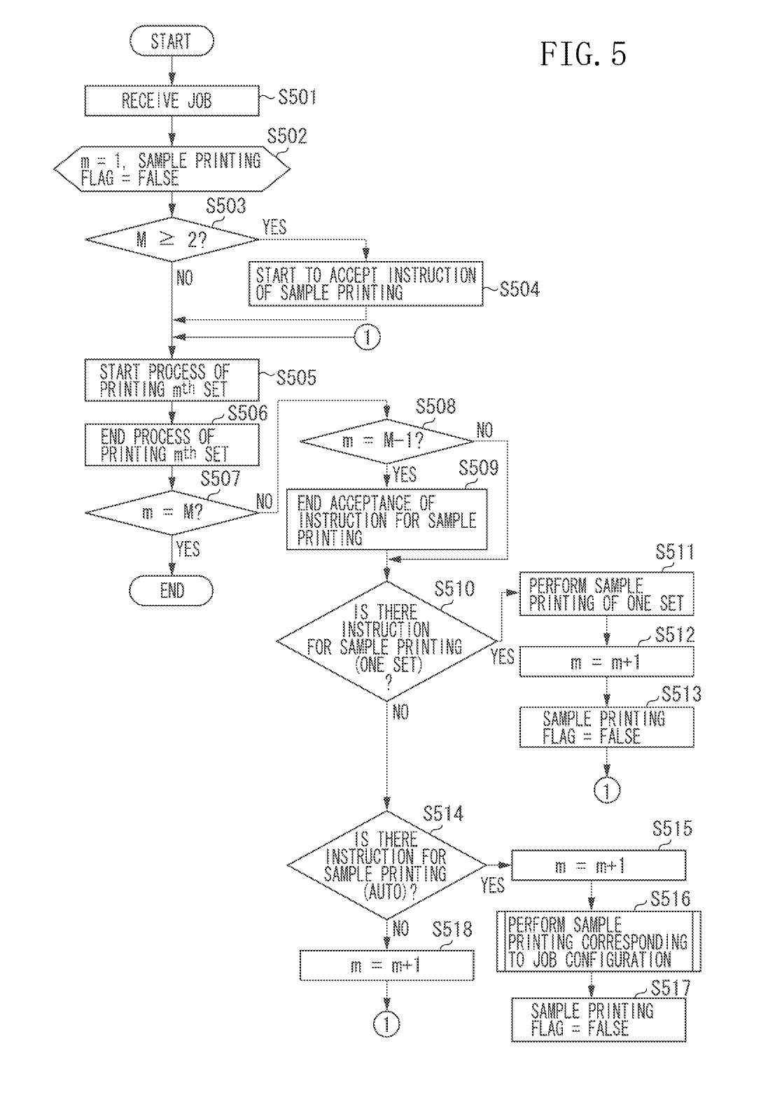

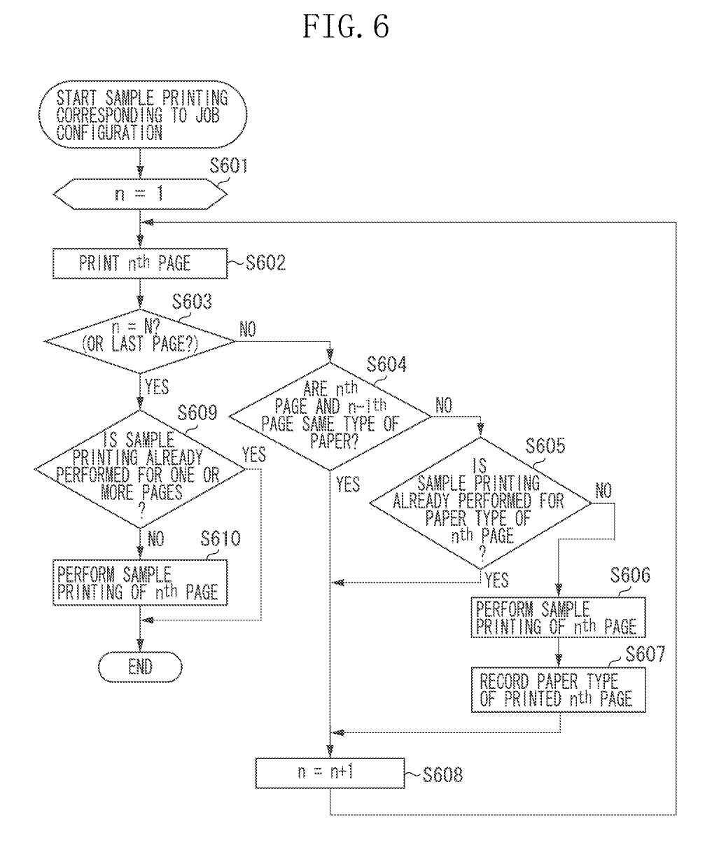

Processes in the present exemplary embodiment are described with reference to the flowcharts in FIGS. 5 and 6. In the flowcharts, a process is performed to print M sets of copies of the data contained in a received job, and the printed paper is discharged to the paper discharge destination X. Hereinafter the above described “sample printing for checking the finishing state” is referred to as sample printing. The steps in the flowcharts are performed when the control unit 205 implements a program stored in the ROM 207, and controls the units in the printing system 1000.

In step S501, the control unit 205 receives a job from the PC 102. In step S502, for initialization, the control unit 205 sets a value “m” of a counter for a number of print copies, to be 1, and sets to FALSE a sample printing flag stored in the RAM 208, which is the flag indicating presence of an instruction to execute sample printing.

In step S503, the control unit 205 determines whether the number “M” set in the received job is 2 or more (whether the job contains a setting for a plurality of print copies or not). If “M≧2” and the control unit 205 determines the job contains a setting for a plurality of print copies (YES in step S503), the process proceeds to step S504. If NO in step S503 (the job does not contain a setting for a plurality of print copies), the process proceeds to step S505. In step S504, the control unit 205 controls the printing system 1000 to start to receive an instruction to execute sample printing. When it is determined that no request for a plurality of print copies is set in the job, the process proceeds to step S505, and the control unit 205 performs a printing process without receiving an instruction to execute sample printing. When “M<2” in step S503, in other words, only one set of data printing is performed, sample printing is almost meaningless. Accordingly, when only one set of data printing is performed in the process, no instruction for sample printing is received.

In step S505, the control unit 205 controls the printer unit 203 to start to print the m^{th} set of the print data. In step S506, the printing process ends.

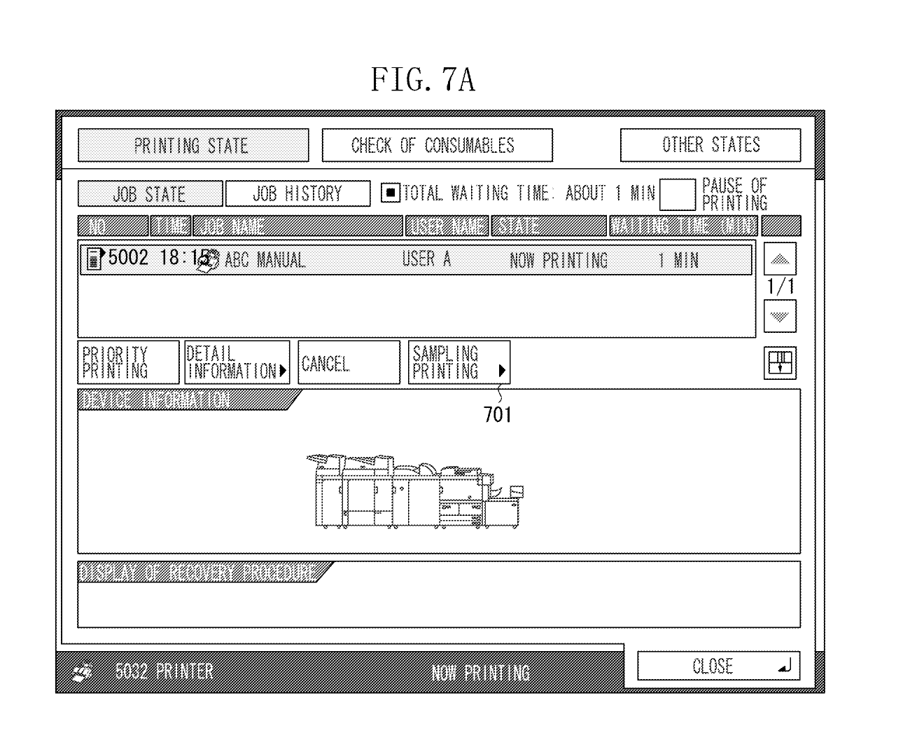

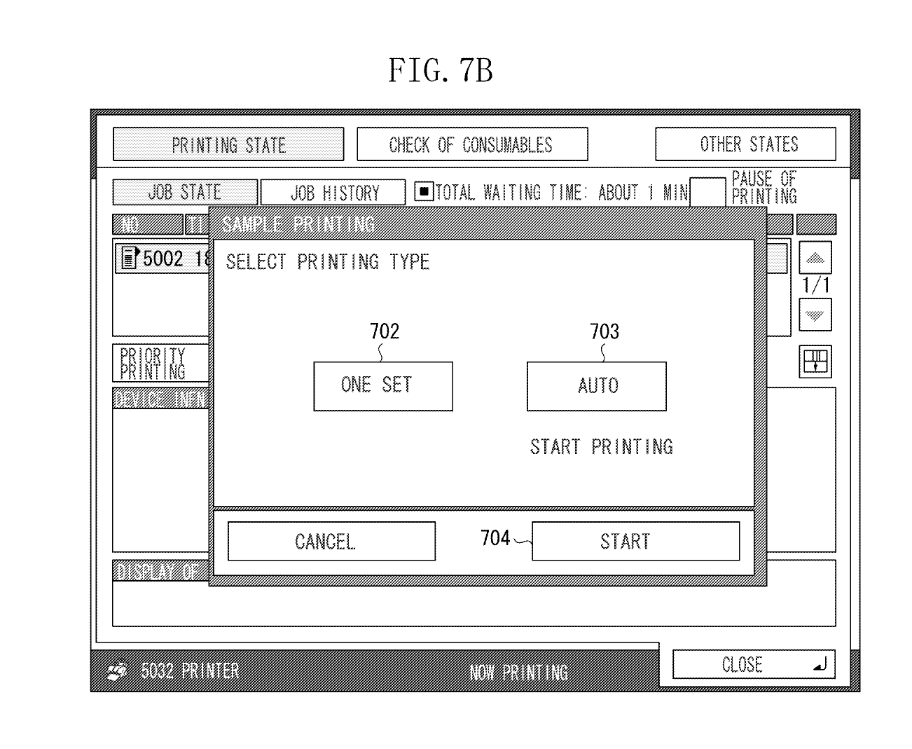

A process is described with reference to FIGS. 7a and 7b, in which the printing system 1000 receives an instruction to execute sample printing from an operator through the operation unit 204 in the present exemplary embodiment. The control unit 205 displays a screen illustrated in FIG. 7a on the touch panel unit 401 provided in the operation unit 204, as a screen displaying a job state. The screen is provided with a sample-printing instruction button 701 to instruct execution of sample printing, which is in a gray-out and unavailable before receipt of a sample-printing instruction is started in step S504. When the control unit 205 starts to receive an instruction to execute sample printing in step S504, the control unit 205 disables the gray-out effect of the sample-printing instruction button 701, and sets the button 701 available on the screen.

When the sample-printing instruction button 701 is pressed, the control unit 205 displays the screen illustrated in FIG. 7b on the touch panel unit 401, to guide an operator to select detail operations about the sample printing. When the operator wants to have a set of print copies of the entire print data as a sample, the operator selects a ONE SET button 702, and presses a print start button 704. When the operator wants the printing system 1000 to automatically extract pages to be output as a sample, so that sample printing of pages that are likely to bring about tint variation during printing is executed, the operator selects an AUTO button 703, and presses the print start button 704. According to the operation of the operator, the control unit 205 stores the instruction information of the pressed buttons into the RAM 208, and changes the sample printing flag stored in the RAM 208 to TRUE. In this way, the printing system 1000 accepts an instruction to execute sample printing. In the present exemplary embodiment, sample printing of one set of the entire print data is referred to as sample printing (one set). In contrast, sample printing of a page that is likely to bring about tint variation and is automatically determined to be output among a plurality of pages corresponding to print data is referred to as sample printing (auto).

The flowchart in FIG. 5 is further described. In step S507, the control unit 205 determines whether the number “m” for the sets of copies already printed in step S506 is equal to the number “M” for the sets of copies designated by the operator. In step S507, if it is determines “m=M” (YES in step S507), the control unit 205 ends the process of the flowchart. In step S507, if it is determines “m≠M” (the number of printed copies has not reached the number designated by the job), the process proceeds to step S508.

In step S508, the control unit 205 determines whether the next set of copies to be printed is the last set of the job (whether “m=M−1” or not). In step S508, if it is determined the next set of copies is the last set of the job (YES in step S508), the process proceeds to step S509. In step S509, the control unit 205 finishes receiving an instruction for sample printing, and turns the sample-printing instruction button 701 in FIG. 7a to gray-out. In contrast, if it is determined the next set of copies is not the last set of the job (NO in step S508), the process proceeds to step S509 while keeping an instruction to execute sample printing acceptable. In this way, no instruction for sample printing is received, when printing of the last set of copies is started, as in the case where a single set of print copies is requested.

In step S510, the control unit 205 determines whether an instruction to execute sample printing (one set) is received from an operator. The determination in step S510 is made based on the sample printing flag and instruction information stored in the RAM 208. More specifically, the control unit 205 determines that an instruction to execute sample printing (one set) is received when the sample printing flag stored in the RAM 208 is TRUE and the instruction information is “sample printing (one set)”. In step S510, if it is determined an instruction to execute sample printing (one set) is received (YES in step S510), the process proceeds to step S511. If it is determined an instruction to execute sample printing (one set) is not received (NO in step S510), the process proceeds to step S514.

In step S511, the control unit 205 executes sample printing of one set of the entire print data, and controls the printer unit 203 and the print paper processing apparatus 200 such that the paper of the sample printing page is output to the paper discharge destination Y, instead of the paper discharge destination X where print copies of the printed data are normally output. In step S512, the control unit 205 increments the “m” value. In step S513, the control unit 205 turns the sample printing flag to FALSE, and proceeds to a printing process of a next set of copies (the process proceeds to step S505).

In step S514, the control unit 205 determines whether an instruction to execute sample printing (auto) is received from an operator. The determination in step S510 is also made based on the sample printing flag and instruction information stored in the RAM 208, as in step S510. More specifically, the control unit 205 determines that an instruction to execute sample printing (auto) is received when the sample printing flag stored in the RAM 208 is TRUE and the instruction information is “sample printing (auto)”. In step S514, if it is determined an instruction to execute sample printing (auto) is received (YES in step S514), the process proceeds to step S515. If it is determined an instruction to execute sample printing (auto) is not received (NO in step S514), the process proceeds to step S518.

In step S515, the control unit 205 increments the “m” value. In step S516, the control unit 205 executes sample printing of the page where tint variation is likely to occur according to the job configuration, while an m^{th} set of the print data is printed. The process in step S516 is described later in detail with reference to FIG. 6. In step S517, the control unit 205 turns the sample printing flag to FALSE, and the process proceeds to step S507. AS described above, in the present exemplary embodiment, in step S516, sample output is executed simultaneously with actual output of objective print product. Alternatively, only sample output may be executed for the page that is likely to bring about tint variation occurring there and may be determined to be a target of sample printing.

In step S518, the control unit 205 increments the “m” value, and proceeds to a printing process of a next set of copies (the process proceeds to step S505).

The sample printing process according to a job configuration in step S516 is described with reference to the flowchart in FIG. 6. The flowchart illustrates a case where one set of print copies is composed of an “N” number of printed pages (each set ends with the N^{th} page).

In step S601, the control unit 205 initializes the counter value, by setting the value “n” of a counter for pages to be printed, to 1. In step S602, the control unit 205 controls the printer unit 203 to print a copy of the n^{th} page. In step S603, the control unit 205 determines whether the page to be printed is the end page of the set of copies (whether “n=N” or not). Depending on a PDL or the configuration of a printing system, the number “N” of pages per set is sometimes unknown at first when the printing is started. Accordingly, the determination in step S603 may be made based on whether there is another page left to be printed, or whether the page just printed contains information as the end page of the set. In step S603, if it is determined that the page to be printed is the end page of the set (YES in step S603), the process proceeds to step S612. If it is determined that the page to be printed is not the end page of the set (NO in step S603), the process proceeds to step S604.

In step S604, the control unit 205 obtains paper type information of the n^{th} page to be printed and paper type information of the n−1^{th} page that is printed before the n^{th} page from the page information monitor unit 212. The paper type information herein is contained in a job, and indicates a paper type used for each page in printing of print data. The control unit 205 compares the obtained paper type information with each other, and determines whether the paper type used in printing of the n^{th} page differs from that used in printing of the n−1^{th} page. In step S604, if it is determined the paper types differ from each other (YES in step S604), the process proceeds to step S605, while if it is determined the paper types are the same with each other (NO in step S604), the process proceeds to step S608. As described above, when the paper types differ from each other, the corresponding page to be printed is likely to bring about tint variation. Accordingly, in the process following step S605, it is determined whether the page requires execution of sample printing to check tint on the paper (whether the page is a sample printing page or not).

In step S605, the control unit 205 determines whether the paper type used in printing of the n^{th} page is the same as that already used in sample printing in the job currently processed. In step S605, if it is determined the paper type is already used in sample printing (YES in step S605), the process proceeds to step S608. In contrast, in step S605, if it is determined the paper type used in printing of the n^{th} page is not used yet in sample printing in the job currently processed (NO in step S605), the process proceeds to step S606.

In step S606, the control unit 205 extracts the n^{th} page to be currently printed as a sample printing page. The control unit 205 executes sample printing of the extracted sample printing page, and controls the printer unit 203 and the print paper processing apparatus 200 such that the paper of the sample printing page is output to the paper discharge destination Y, instead of the paper discharge destination X where print copies of the printed data are normally output. The control unit 205 stores the information about the sample printing into the RAM 208. In step S607, the control unit 205 also performs control to store information about the paper type of the page on which sample printing was executed because of change in paper types, into the RAM 208. The determination in step S605 is made when the control unit 205 refers to the paper type information stored in step S607.

In step S608, the control unit 205 increments the “n” value, and proceeds to printing process of a next page (the process proceeds to step S602).

In step S609, the control unit 205 determines whether sample printing has been already executed for one or more pages in the process. The determination in step S609 is made when the control unit 205 checks for information about executed sample printing stored in the RAM 208 in step S606. If sample printing is executed for one or more pages, in other words, if information about executed sample printing for one or more pages is stored in the RAM 208 (YES in step S609), the flowchart ends. In contrast, if there is not a page where tint variation is likely to occur and no sample printing is executed (NO in step S609), in other words, if information about executed sample printing for one or more pages is not stored in the RAM 208, the process proceeds to step S610.

In step S610, the control unit 205 extracts the n^{th} page to be currently printed (the end page of the set) as a sample printing page. The control unit 205 executes sample printing of the extracted sample printing page, and controls the printer unit 203 and the print paper processing apparatus 200 such that the paper of the sample printing page is output to the paper discharge destination Y, instead of the paper discharge destination X where print copies of the printed data are normally output. After the process of the flowcharts ends, the process returns to the flowchart in FIG. 5 to print a next set of print copies.

Based on the above process, in step S604, the control unit 205 determines whether the page to be printed is likely to bring about tint variation. The page determined to be likely to bring about tint variation is extracted as a sample printing page, and sample printing of the page is executed. Such process enables extraction of a page where tint variation is likely to occur, and sample output of the page can be performed to check the finishing state at more efficient timing, which enhances effectiveness of checking by operator. In addition, as another effect, the cases are reduced where reprint is required due to poor image quality of print product that is caused by tint variation. The reduction can result in improved productivity throughout the printing workflow.

In the present invention, sample output is automatically performed in consideration of paper types, in printing a job that is composed of various types of paper. The automatic output saves steps which an operator takes in checking the finishing state of printed product in consideration of paper types of the job. Furthermore, in the present invention, sample output is automatically performed in consideration of information of paper type and print setting of a job, which can reduce the risk of missing tint variation occurring on a part of paper contained in print product and resulting in print product having poor image quality.

Even when there is no page that is determined to be likely to bring about tint variation, sample printing is executed for the end page of one set of print copies in the processes in steps S609 and S610. Therefore, users are guaranteed to check the finishing state of print product.

In the above first exemplary embodiment, tint variation is dealt with in the case where different paper types are used in printing. However, print density is another factor that adversely affects the finishing state such as tint variation. If a print product contains a page at an extremely high or low density, the page may have image quality that is considerably different from the image quality of the other pages when the certain quality is maintained as to the other pages throughout printing processing. Furthermore, whether a special toner (e.g., clear toner) is used in printing or not is an important factor in monitoring a change in finishing state. If a special toner is used on a page during printing, a printing process control of the page is different from the other pages, in fixing the toner, for example. It is thus not appropriate to determine that the printing of the page using special toner has no trouble in image quality even if the other pages maintain a consistent image quality throughout printing processing. Accordingly, print density and use of special toner have to be taken into consideration when the finishing state is checked. If no consideration is given to print density and use of special toner, an operator may not notice a page of inadequate image quality contained in print product, similar to the exemplary embodiment described above. In this second exemplary embodiment, this problem is addressed.

The image forming system applied in the present exemplary embodiment is similar to that applied in the first exemplary embodiment, which is not described.

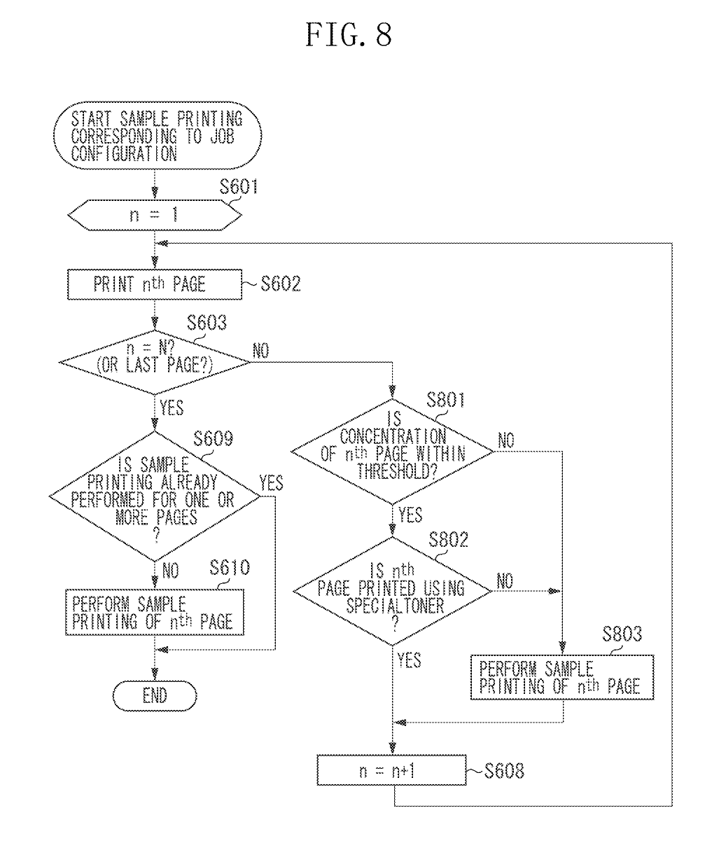

FIG. 8 is a flowchart illustrating steps in a sample printing process according to a job configuration in step S516 of the flowchart in FIG. 5, in the present exemplary embodiment. The flowchart in FIG. 8 also illustrates a case where one set of print copies is composed of an “N” number of printed pages (each set ends with the N^{th} page). The steps similar to those in the flowchart in FIG. 6 are designated with the same reference numerals, which are not described.

In step S801, the control unit 205 determines whether the density of an n^{th} page is within a predetermined range of reference values. In step S801, if it is determined the density of an n^{th} page is within a predetermined range of reference values (YES in step S801), the process proceeds to step S802. If it is determined the density of an n^{th} page is not within a predetermined range of reference values (NO in step S801), the process proceeds to step S803. When the density is extremely high or low, the page having that density is likely to bring about tint variation. Accordingly, sample printing of the page is executed in step S803. The determination in step S801 is made based on comparison performed by the control unit 205 between toner concentration information contained in the job and the predetermined reference values. The predetermined reference values can be set by a user as desired, but may be automatically set according to toner concentration information of each page contained in the job. In the latter case, for example, the predetermined reference values may be determined by calculating an average value of toner concentrations of pages in the job and setting the reference values of toner concentration to be from 10% to 90% when the average value is 50%

In step S802, the control unit 205 determines whether a special toner is used in printing the n^{th} page. The special toner herein includes a toner different from normal C/M/Y/K toner such as clear toner. In step S802, if it is determined a special toner is used (YES in step S802), the process proceeds to step S803. If it is determined a special toner is not used (NO in step S802), the process proceeds to step S611. When a special toner is used in printing a page, tint variation is likely to occur on the page, and thereby sample printing of the page is executed in step S803. The determination in step S802 is made based on check of information about use of the special toner contained in the job, by the control unit 205.

In step S803, the control unit 205 extracts the n^{th} page to be currently printed as a sample printing page. The control unit 205 executes sample printing of the extracted sample printing page, and controls the printer unit 203 and the print paper processing apparatus 200 such that the paper of the sample printing page is output to the paper discharge destination Y, instead of the paper discharge destination X where print copies of the printed data are normally output. The control unit 205 further stores the information about the executed sample printing into the RAM 208. In step S609 in FIG. 8, the control unit 205 determines whether sample printing has been executed for one or more pages based on the information about the executed sample printing stored in step S803.

In the present invention, sample output is automatically executed in consideration of toner concentration, during printing of a job that contains images printed at different toner concentrations. The automatic output saves the steps an operator takes to check the pages that are likely to bring about inadequate image quality due to toner concentration through comparison with original document. Furthermore, in the present invention, sample output is executed in consideration of the pages printed using a special toner. The sample output enables operators to find defects on pages that have been often overlooked when conventional sample output functions are used.

In a third exemplary embodiment, a method is described as the combination of the second exemplary embodiment and the method described in the second exemplary embodiment. The method of the present exemplary embodiment enables sample printing according to different factors that cause tint variation, such as different paper types, toner concentration, and use of special toner. The image forming system applied in the present exemplary embodiment is similar to that applied in the first exemplary embodiment, which is not described.

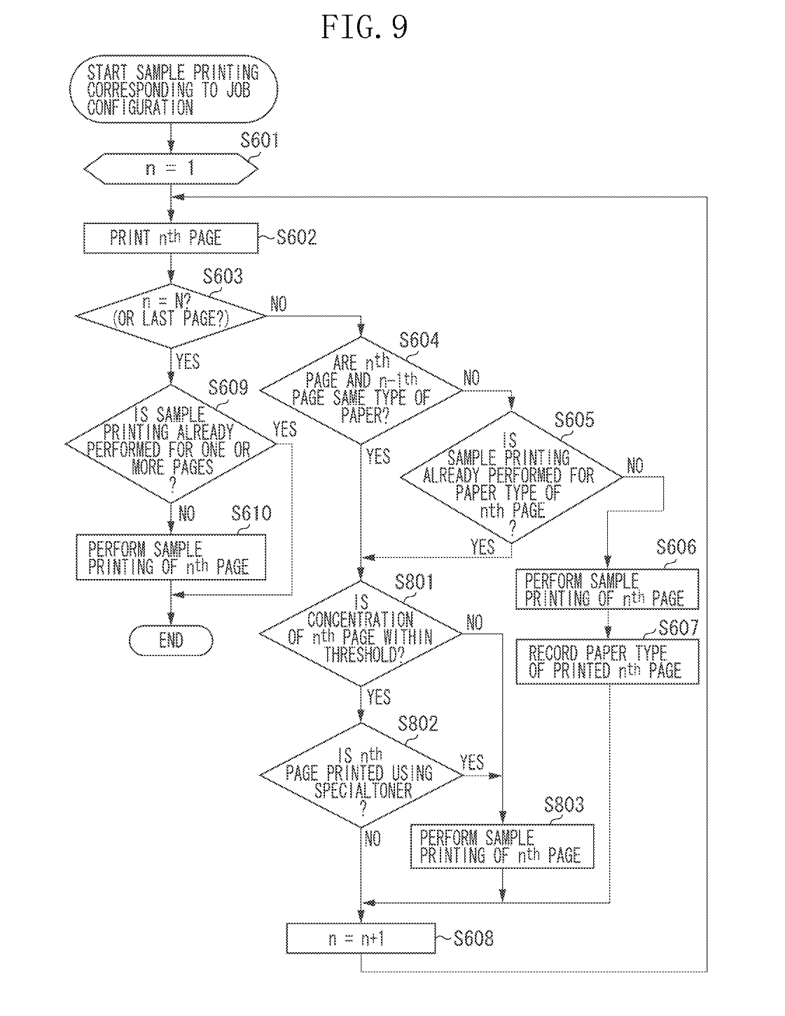

FIG. 9 is a flowchart illustrating steps in a sample printing process according to a job configuration in step S516 of the flowchart in FIG. 5, in the present exemplary embodiment. The flowchart in FIG. 9 also illustrates a case where one set of print copies is composed of an “N” number of printed pages (each set ends with the N^{th} page). The steps similar to those in the flowcharts in FIGS. 6 and 8 are designated with the same reference numerals, which are not described.

In the flowchart in FIG. 9, if YES in step S604 or step S605, it is decided that no sample printing for a factor of different paper types is required. In this case, furthermore in steps S801 and S802 in the flowchart in FIG. 9, the control unit 205 determines whether sample printing is required for the factors of toner concentration and special toner.

The processes in the flowchart in FIG. 9 achieve sample printing according to different factors that cause tint variation, such as different paper types, toner concentration, and use of special toner, and enable operators to find defects on pages that have been often overlooked when conventional sample output functions are used.

The other exemplary embodiments of the present invention are described. In recent years, a printing form called variable data print (hereinafter, referred to as VDP) has been used to print different contents for each set (record) as to a part of print outcome. Use of the VDP enables, for example, printing of direct mails containing different contents customized for each individual while printed on the same background. To achieve such printing, the VDP uses two types of data to be printed: fixed data that is commonly used in every record, and variable data that is different for every record. The fixed data is repeatedly used in printing, and variable data different for every record is used with the same fixed data in printing. For example, in the case of direct mails for individuals, one brochure made from the variable data for each individual is called one record.

If the processes for sets of print copies in the first exemplary embodiment are performed for each record, the present invention can be applied to the sample printing of print product using the VDP. For example, in the flowchart in FIG. 5, the sample printing process for sets of print copies can be performed for records where “M” is the number of records an operator wants and “m” is the number of printed records. The detail processes are similar to those in the first exemplary embodiment, which are not described.

These processes using the VDP also enables sample output of a page for checking of finishing state at more efficient timing, enhancing effectiveness of checking by operator. Especially in the VDP, in contrast to normal printing of plural sets of print copies, different records contain different contents, and thereby extraction of only one record as a sample is not very effective for check of finishing state. This does not mean extraction of every page of a plurality of records is useful instead, which requires much cost and steps. According to the present invention, even if sample printing is repeatedly executed for a plurality of records, only a page that is useful for check in each record is output as a sample printing page, which reduces cost and steps for checking while the effectiveness is maintained.

In the above exemplary embodiments, sample printing is executed while print data in a job is printed, but the present invention is applicable to the case where sample printing is executed in other timing. For example, the control unit 205 may check the entire content of print data before printing of the print data, and determine pages where tint variation is likely to occur (e.g., a page of a paper type different from that of the previous page), so that the control unit 205 can print the pages where tint variation is likely to occur and sample printing thereof is necessary, before printing of the entire print data is completed. In this case, no paper discharge destination is used for print copies of the entire print data, and thereby there is no need to control switch paper discharge destinations.

While the present invention has been described above in terms of specific embodiments, it is to be understood that the invention is not limited to these embodiments. The present invention can be achieved by execution of the following process. A software (program) to implement the functions of the above described exemplary embodiments is provided to a system or apparatus through a network or various storage media, and a computer (or, central processing unit (CPU) or micro processing unit (MPU)) of the system or apparatus reads and executes the program. In this case, the program and the storage medium storing the program constitute the present invention.

The present invention is not limited to the above embodiments, and it is obvious that various changes and modifications can be made to the present invention without departing from the scope of this invention as set forth in the following claims.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-059429 filed Mar. 16, 2010, which is hereby incorporated by reference herein in its entirety.

What is claimed is:

1. An image forming apparatus having a function to execute sample printing for a part of print data contained in a job to check a finishing state of print product when the print data is printed, the image forming apparatus comprising:
a determining unit configured to determine whether each of a plurality of pages where the print data is printed is likely to bring about tint variation when the page is printed;
an extracting unit configured to extract a page determined to be likely to bring about the tint variation by the determining unit as a sample printing page that requires execution of sample printing to check tint on paper; and
an outputting unit configured to execute sample printing of the sample printing page extracted by the extracting unit, and output a print product of the sample printing.

2. The image forming apparatus according to claim 1, wherein the determining unit determines a page of a paper type used in printing and different from a paper type of a primarily preceding printed page to be likely to bring about the tint variation, based on information contained in the job about paper type for each page used in printing.

3. The image forming apparatus according to claim 2, wherein when sample printing has already been executed in printing of the print data, for a paper type of a page determined to be likely to bring about the tint variation, the extracting unit does not extract the page as a sample printing page.

4. The image forming apparatus according to claim 2, wherein the determining unit determines a page having a toner concentration out of a reference range to be likely to bring about the tint variation, based on information contained in the job for each page about toner concentration used in printing, in addition to a determination based on the paper type information.

5. The image forming apparatus according to claim 2, wherein the determining unit determines a page printed using a special toner to be likely to bring about the tint variation, based on information for each page about special toner used in printing of the job, in addition to a determination based on the paper type information.

6. The image forming apparatus according to claim 1, wherein, in the case where no page is determined to be likely to bring about the tint variation by the determining unit, the extracting unit extracts an end page of the plurality of pages as the sample printing page.

7. The image forming apparatus according to claim 1, wherein the outputting unit outputs print product of the sample printing to a paper discharge destination that is different from a paper discharge destination for print product of the print data.

8. A method of controlling an image forming apparatus having a function to execute sample printing for a part of print data contained in a job to check a finishing state of print product when the print data is printed, the method comprising:
determining whether each of a plurality of pages where the print data is printed is likely to bring about tint variation when the page is printed;
extracting a page determined to be likely to bring about the tint variation by the determination as a sample printing page that requires execution of sample printing to check tint on paper; and
executing sample printing of the extracted sample printing page, and outputting print product of the sample printing.

9. The method of controlling an image forming apparatus according to claim 8, wherein, in the determining, based on information contained in the job for each page about paper type used in printing, a page of a paper type different from a paper type of a primarily preceding printed page is determined to be likely to bring about the tint variation.

10. The method of controlling an image forming apparatus according to claim 9, wherein, in the extracting, when sample printing has been executed in printing of the print data for a paper type of a page determined to be likely to bring about the tint variation, the page is not extracted as a sample printing page.

11. The method of controlling an image forming apparatus according to claim 9, wherein, in the determining, based on information contained in the job for each page about toner concentration used in printing, in addition to determining based on the paper type information, a page having a toner concentration out of a reference range is determined to be likely to bring about the tint variation.

12. The method of controlling an image forming apparatus according to claim 9, wherein, in the determining, based on information contained in the job for each page about special toner used in printing, in addition to determining based on the paper type information, a page to be printed using the special toner is determined to be likely to bring about the tint variation.

13. The method of controlling an image forming apparatus according to claim 8, wherein, in the extracting, when no page is determined to be likely to bring about the tint variation in the determination, the end page of the plurality of pages is extracted as a sample printing page.

14. The method of controlling an image forming apparatus according to claim 8, wherein, in the outputting, print product of the sample printing is output to a paper discharge destination that is different from a paper discharge destination for print product of the print data.

15. A computer-readable storage medium storing a program that causes a computer to execute the method of controlling an image forming apparatus according to claim 8.
